(19) United States
(12) Patent Application Publication
(10) Pub. No.: US 2017/0256014 A1
(43) Pub. Date: Sep. 7, 2017

(54) METHOD AND SYSTEM FOR GENERATING A HOSPITAL RECOMMENDATION

(71) Applicant: XpertDox, LLC, Birmingham, AL (US)

(72) Inventor: Sameer Ather, Birmingham, AL (US)

(21) Appl. No.: 15/412,021

(22) Filed: Jan. 22, 2017

Related U.S. Application Data
(60) Provisional application No. 62/302,188, filed on Mar. 2, 2016.

(51) Int. Cl. G06Q 50/22; G06F 17/30

(52) U.S. Cl. CPC G06Q 50/22; G06F 17/30867; G06F 17/3053; G06F 17/30554

(57) ABSTRACT

A method and system for generating a hospital recommendation is disclosed. The method includes receiving an input search criterion by a hospital recommendation platform using one or more communication devices, identifying one or more hospital according to the received input search criterion based on a plurality of attributes of one or more affiliated doctors classified under a plurality of domains, comparing one or more identified hospitals based on a parameter, and displaying a list of hospital to the user corresponding to the received input search criterion.

### CROSS-REFERENCE TO RELATED APPLICATION

The present application is related to provisional patent application Ser. No. 62/302,188, filed on Mar. 2, 2016, and titled “HOSPITAL RECOMMENDATION SYSTEM”. The entire disclosure of the above patent application is hereby incorporated by reference.

### FIELD OF THE INVENTION

The present application generally relates to healthcare services. Particularly, the present invention relates to recommendation of a list of hospitals based on an input search criterion.

### BACKGROUND

There are no objective measures by which one can identify a hospital's expertise in a particular disease, medicine or procedure. Some hospitals display their expertise on their own website but there is no third party validation for the same. Thus, patients depend on their primary care physician to guide them to a hospital for expert advice about their disease, medicines or procedures. Further, the current system does not allow for comparison of two or more hospitals for a particular search criterion (“Search Term”) that could be a disease, medicine or procedure.

In conventional systems, the hospital recommendation is based on different factors such as patients' review of hospitals, hospitals' nomination by a panel of experts, and number of patients seen by a hospital. However, these factors limit the scope of hospital recommendation system for searching and recommending hospitals based on the input search criteria.

Thus, in light of the above mentioned background art, it is evident that, there is a need for a method and system that overcomes the above stated problems. There is a need for a method and system for generating recommendation of a list of hospitals based on an input search criterion. A method and system for generating a hospital recommendation is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for generating a hospital recommendation.

In accordance with one embodiment of the present invention, a method for generating a hospital recommendation to a user (102) is provided. The method for generating the hospital recommendation to the user (102) comprises receiving an input search criterion by a hospital recommendation platform (108) using one or more communication devices (104; 114), identifying one or more hospital according to the received input search criterion based on a plurality of attributes of one or more affiliated doctors classified under a plurality of domains, comparing one or more identified hospitals based on a parameter, and displaying a list of hospital to the user (102) corresponding to the received input search criterion.

In accordance with one embodiment of the present invention, the input search criterion is based on “Search Term”.

In accordance with one embodiment of the present invention, identifying one or more hospitals is based on various attributes of affiliated doctors in different domains. List of the domains includes, but are not limited to Clinical expertise in the search criterion, research contributions related to search criterion, and Subject authority. The subject authority is based on education contributions, leadership roles held among peers and number of referrals.

In accordance with one embodiment of the present invention, identifying one or more hospitals further comprises obtaining a list of doctors affiliated to a hospital based on a first scoring method; applying a second scoring method to the obtained list of doctors; and calculating a score for the hospital based on a cumulative score obtained from said second scoring method.

In accordance with one embodiment of the present invention, the cumulative score is an aggregate score of the list of doctors affiliated to the hospital.

In accordance with one embodiment of the present invention, the parameter is the cumulative score obtained from the second scoring method.

In accordance with one embodiment of the present invention, the first scoring method comprises calculation of a score for a doctor based on at least one of the various weights to each attributes and strengths of association of each attribute with the input search criterion.

In accordance with one embodiment of the present invention, the method further enables auto completion of the input search criterion.

In accordance with one embodiment of the present invention, the method further enables displaying hospital recommendations in various forms.

In accordance with one embodiment of the present invention, a system (100) for generating a hospital recommendation to a user (102) using a hospital recommendation platform (108) communicatively coupled with one or more communication devices (104; 114) through a communication network (110) is provided. The system (100) for generating the hospital recommendation to the user (102) comprises an input detection module (404), configured to receive, detect and interpret an input search criterion by the hospital recommendation platform (108) using one or more communication devices (104; 114), an information storage module (406), configured to store information related to one or more hospital and information related to the user (102), an analytics module (408), configured to compare one or more identified hospital based on a scoring mechanism and provide a list of hospital correspondence to the input search criterion, and one or more processing modules (410), configured to process the input search criterion and identify one or more hospital corresponding to the input search criterion based on a plurality of attributes.

In accordance with one embodiment of the present invention, the system (100) for generating a hospital recommendation suggests auto completion of the input search criterion.

In accordance with one embodiment of the present invention, if there are multiple affiliations for a particular doctor, the system gives weights to each affiliation based on, but not limited to, the size of the hospital and number of affiliated hospitals for the given doctor.

In accordance with one embodiment of the present invention, the system (100) for generating a hospital recommendation is multifaceted. The hospital recommendations is not based on a single attribute, rather, it is based on various attributes of affiliated doctors in different domains. List of attributes includes, but is not limited to number of publications as first or last author for each search term, number of publications not as first or last author for each search term, number of citations for publications in which the doctor is first or last author for each search term, number of citations for publications in which the doctor is not a first or last author for each search term, ratio of original article and total publications, ratio of human studies and total publication, number of patients a doctor sees with a particular disease, number of a particular medicine prescribed by a doctor, number of a particular procedure performed by a doctor, invited chapters in a book on a particular topic, leadership positions in a national organization, number of referrals from peers, and honor in local and regional chapters.

In accordance with one embodiment of the present invention, the system (100) for generating a hospital recommendation is unbiased. The system (100) does not require input from either patients or hospitals and thus avoids a bias.

In accordance with one embodiment of the present invention, the system (100) for generating a hospital recommendation provides personalized hospital recommendations. Identification of hospital is based on the “Search Term”.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a system for generating a hospital recommendation, in accordance with various embodiments of the present invention;

FIG. 2 illustrates a flowchart for generating a hospital recommendation, in accordance with various embodiments of the present invention.

FIG. 3a illustrates a user interface for receiving an input search criterion, in accordance with various embodiments of the present invention.

FIG. 3b illustrates a user interface for providing search term suggestions, in accordance with various embodiments of the present invention.

FIG. 3c illustrates a user interface for selecting a category, in accordance with various embodiments of the present invention.

FIG. 3d illustrates a user interface for displaying a list of hospital recommendation, in accordance with various embodiments of the present invention.

FIG. 3e illustrates a user interface for filtering the list of hospital recommendation, in accordance with various embodiments of the present invention.

FIG. 4 illustrates a block diagram of a hospital recommendation platform, in accordance with various embodiments of the present invention.

### DETAILED DESCRIPTION

Some embodiments, illustrating its features, will now be discussed in detail. The words “comprising”, “having”, “containing”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an”, and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a method for generating a hospital recommendation to a user (102) is provided. The method for generating the hospital recommendation to the user (102) comprising receiving an input search criterion by a hospital recommendation platform (108) using one or more communication devices (104; 114), identifying one or more hospital according to the received input search criterion based on a plurality of attributes of one or more affiliated doctors classified under a plurality of domains, comparing one or more identified hospitals based on a parameter, and displaying a list of hospital to the user (102) corresponding to the received input search criterion.

In accordance with one embodiment of the present invention, a system (100) for generating a hospital recommendation to a user (102) using a hospital recommendation platform (108) communicatively coupled with one or more communication devices (104; 114) through a communication network (110) is provided. The system (100) for generating the hospital recommendation to the user (102) comprising an input detection module (404), configured to receive, detect and interpret an input search criterion by the hospital recommendation platform (108) using one or more communication devices (104; 114), an information storage module (406), configured to store information related to one or more hospital and information related to the user (102), an analytics module (408), configured to compare one or more identified hospital based on a scoring mechanism and provide a list of hospital correspondence to the input search criterion, and one or more processing modules (410), configured to process the input search criterion and identify one or more hospital corresponding to the input search criterion based on a plurality of attributes.

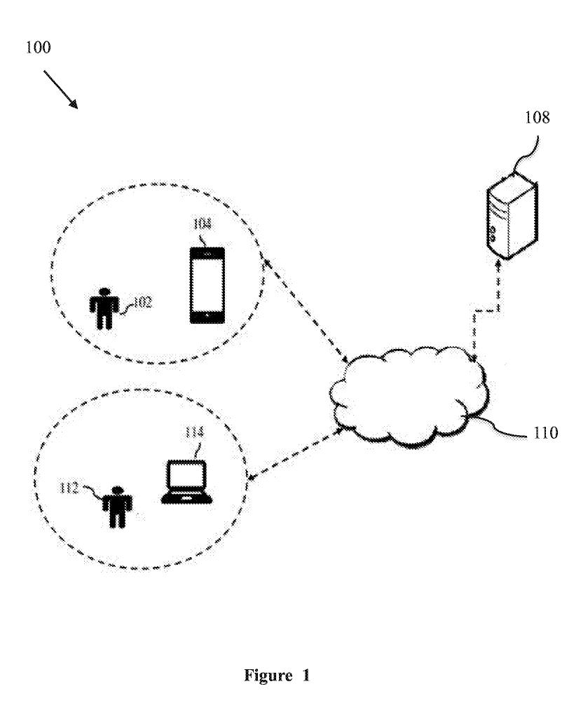

Referring to FIG. 1 is the system for generating the hospital recommendation, in accordance with various embodiments of the present invention. The system (100) includes the communication device (104) associated with the user (102), the communication device (114) associated with a user (112), and the hospital recommendation platform 108. The communication device (104) and the communication device (114) communicate with the hospital recommendation platform (108) through the communication network (110). The functions and capabilities of the communication device (104) are same as the functions and capabilities of the communication device (114). Examples of the user (102) include, but are not limited to a user, a patient, healthcare personnel, an administrator, a caretaker, an assistant, and any authority.

In accordance with one embodiment of the present invention, the communication device (104) refers to a handheld electronic device that can be used to communicate over the communication network (110). Examples of the communication device (104) include, but are not limited to a cell phone, a smart phone, a cellular phone, a cellular mobile phone, a personal digital assistant (PDA), a navigation terminal, a personal computer, a laptop, and a tablet computer. Examples of types of the communication network include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

In accordance with one embodiment of the present invention, the hospital recommendation platform (108) refers to a platform that provides a list of hospital recommendation to the user (102) for an input search criterion. The user (102) inputs the search criterion through the communication device (104). The hospital recommendation platform (108) receives the input search criterion from the communication device (104). In an embodiment, the hospital recommendation platform (108) stores information related to one or more hospitals. The hospital recommendation platform (108) processes the input search criterion and identifies one or more hospital correspondence to the search criterion. In an embodiment, the hospital recommendation platform (108) identifies one or more hospital based on comparison among one or more hospitals. In an embodiment, identifying one or more hospitals further includes obtaining a list of doctors affiliated to a hospital based on a first scoring method, applying a second scoring method to the obtained list of doctors, and calculating a score for the hospital based on a cumulative score obtained from the second scoring method. The cumulative score is an aggregate score of the list of doctors affiliated to the hospital. The first scoring method comprises calculating a score for a doctor based on at least one of the various weights to each attributes and strengths of association of each attribute with the input search criterion.

In accordance with one embodiment of the present invention, the comparison among one or more hospitals is based on a parameter. The parameter is the cumulative score obtained from the second scoring method.

In accordance with one embodiment of the present invention, if there are multiple affiliations for a particular doctor, the hospital recommendation platform (108) gives weights to each affiliation based on, but not limited to, the size of the hospital and number of affiliated hospitals for the given doctor.

In accordance with one embodiment of the present invention, the hospital recommendation platform (108) displays a list of hospital recommendation based on a comparative score of the hospitals. In an embodiment, the hospital having a higher score is displayed on the top.

In accordance with one embodiment of the present invention, the hospital recommendations is not based on a single attribute, rather, it is based on various attributes of affiliated doctors in different domains. Examples of the domains include, but are not limited to clinical expertise for a search term, research contributions related to search term, and subject authority. The subject authority is based on education contributions, leadership roles held among peers and number of referrals. Examples of attributes include, but is not limited to number of publications as first or last author for each search term, number of publications not as first or last author for each search term, number of citations for publications in which the hospital is first or last author for each search term, number of citations for publications in which the hospital is not a first or last author for each search term, ratio of original article and total publications, ratio of human studies and total publication, number of patients a hospital sees with a particular disease, number of a particular medicine prescribed by a hospital, number of a particular procedure performed by a hospital, invited chapters in a book on a particular topic, leadership positions in a national organization, number of referrals from peers, and honor in local and regional chapters.

In accordance with one embodiment of the present invention, the first scoring mechanism includes assigning various weights to each attribute of affiliated doctors. In another embodiment, the first scoring mechanism includes analyzing strengths of association of each attribute of affiliated doctors with the input search criterion. The individual doctor scores will be calculated based on at least one of the various weights to each attribute and strength of association of each attribute with the input search criterion. Further, for a given search criterion, the score for the hospital will be the cumulative score obtained from the second scoring method. For a particular search criterion, the hospital associated with highest score will be displayed on the top. In an embodiment, displaying a list of hospital recommendations based on the descending order of the scores. In an embodiment, the hospital recommendation is unbiased. The hospital recommendation platform (108) does not require input from either patients or hospitals and thus avoids a bias. In an embodiment, the hospital recommendation platform (108) provides personalized hospital recommendations based on the “Search Term”. Furthermore, the hospital recommendation platform (108) displays a list of hospital recommendations in various forms. Example of various forms includes, but is not limited to a graphical chart, a tabular form, voice guidance, a multimedia element, an animated report, and an interactive web element.

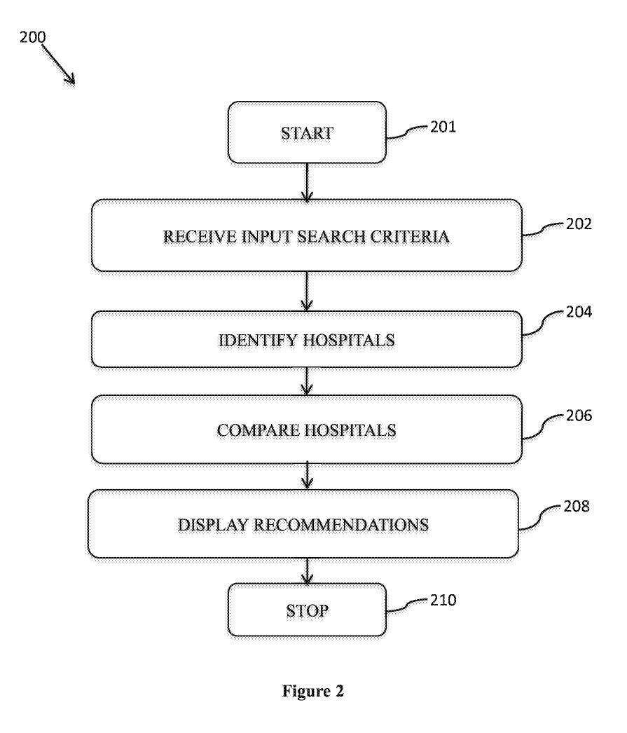

FIG. 2 illustrates a flowchart (200) for generating a list of hospital recommendations, in accordance with various embodiments of the present invention.

At step (201), the flowchart (200) initiates.

At step (202), the hospital recommendation platform (108) receives the input search criterion from the communication device (104). In an embodiment, the hospital recommendation platform (108) receives the input search criterion from a registered communication device. In another embodiment, the hospital recommendation platform (108) receives the input search criterion from a registered user. In an embodiment, the hospital recommendation platform (108) stores various information related to one or more hospitals.

At step (204), the hospital recommendation platform (108) processes the input search criterion and identifies one or more hospital correspondence to the search criterion. In an embodiment identifying one or more hospitals further includes obtaining a list of doctors affiliated to a hospital based on a first scoring method, applying a second scoring method to the obtained list of doctors, and calculating a score for the hospital based on a cumulative score obtained from the second scoring method. The cumulative score is an aggregate score of the list of doctors affiliated to the hospital. The first scoring method comprising calculating a score for a doctor based on at least one of the various weights to each attributes and strengths of association of each attributes with the input search criterion. If there are multiple affiliations for a particular doctor, the hospital recommendation platform 108 gives weights to each affiliation based on, but not limited to, the size of the hospital and number of affiliated hospitals for the given doctor.

At step (206), the hospital recommendation platform (108) compares one or more hospitals based on based on a parameter. In an embodiment, the parameter is the cumulative score obtained from the second scoring method

At step (208), the hospital recommendation platform (108) displays a list of hospital recommendations correspondence to the input search criterion. In an embodiment, displaying a list of hospital recommendations based on the descending order of the scores. At step (210), the flowchart (200) terminates.

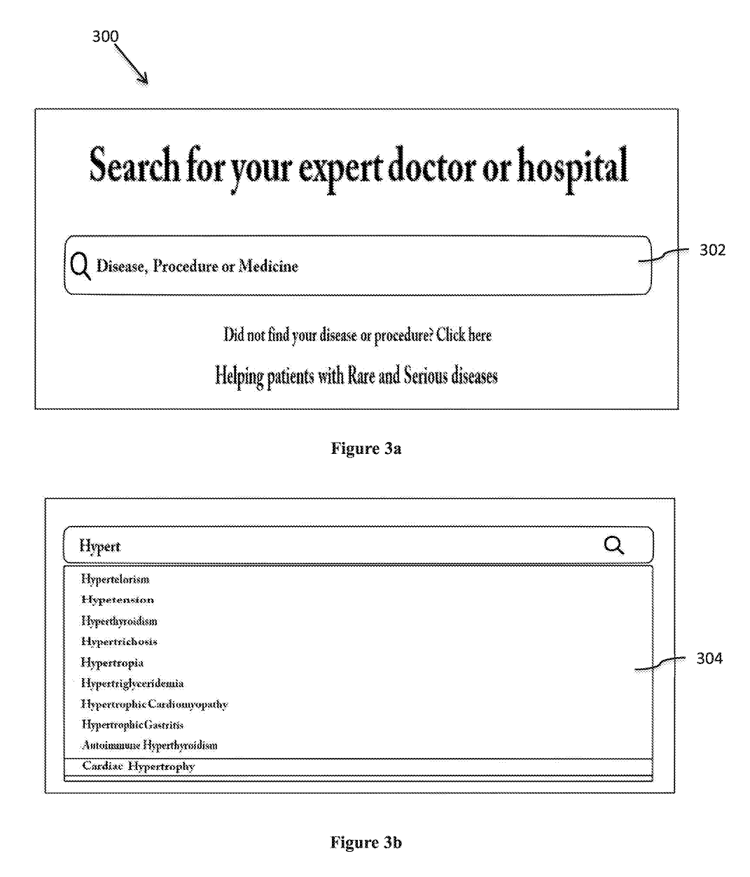

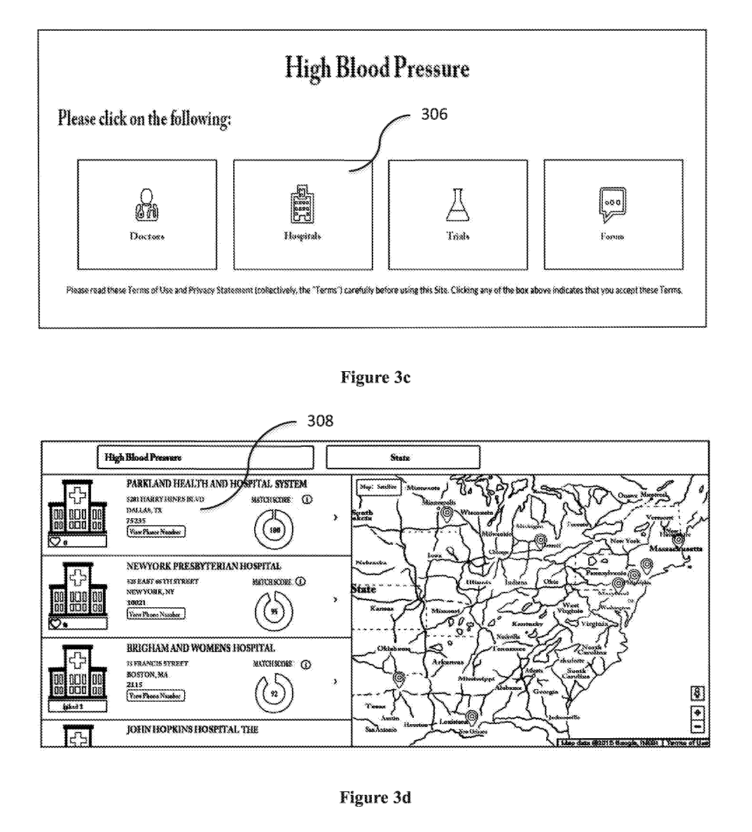

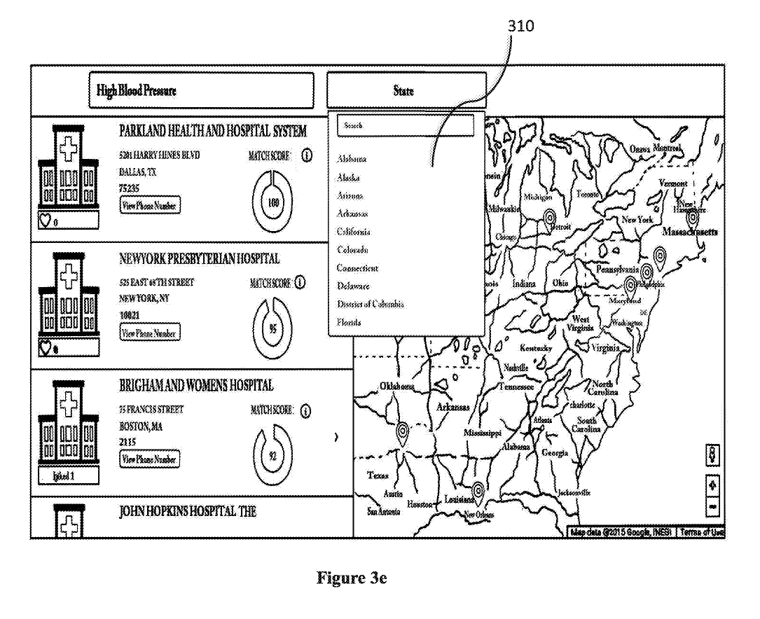

Referring to the FIG. 3a illustrates a user interface (302) for receiving an input search criterion, in accordance with various embodiments of the present invention. In an embodiment, the user interface (302) is a search box. Search boxes are accompanied by a search button. In another embodiment, the user interface (302) is an input text box. In yet another embodiment, the user interface (302) is a search field. In an embodiment, the user interface (302) includes guided text. In context of the present invention, the guided text is disease, procedure, or medicine.

Referring to the FIG. 3b illustrates a user interface (304) for providing search term suggestions, in accordance with various embodiments of the present invention. In an embodiment, the user interface (304) displayed the search term suggestions using ontology. In an embodiment, the user interface (304) displayed the search term suggestions based on grammar and dictionary. In some examples, the user interface (304) may receive one or more indications of input to select one or more keys of a keyboard. Responsive to receiving the indications, the user interface (304) may utilize a language model to determine one or more word suggestions. For instance, the user interface (304) may determine a probability that a string of characters corresponding to one or more selected keys is included in or is a misspelling of at least one of the word suggestions. The user interface (304) may rank each word suggestion based on a probability that the word suggestion is the word actually intended by the user. For example, if the user interface (304) may receive a series of one or more character “hypert”, it displays one or more search term suggestions such as Hypertelorism, Hypertension, Hyperthyroidism, and the like.

Referring to the FIG. 3c illustrates a user interface (306) for selecting a category, in accordance with various embodiments of the present invention. The user (102) may select one of the displayed categories. In an embodiment, the user interface 306 may be a web element. In another embodiment, the user interface (306) may include a radio button. In yet another embodiment, the user interface (306) may include a check box. In yet another embodiment, the user interface (306) may include an interactive web element.

Referring to the FIG. 3d illustrates a user interface (308) for displaying a list of hospital recommendation, in accordance with various embodiments of the present invention. In an embodiment, the user interface (308) displays computed score of each hospital. In another embodiment, the user interface (308) displays physical address of each hospital. In an embodiment, the physical address of a hospital is displayed on an electronic map. In yet another embodiment, the user interface (308) displays a web button correspondence to more details about the hospital. When the user (102) clicks the web button correspondence to more details about the hospital, more information about the hospital will be displayed.

Referring to the FIG. 3e illustrates a user interface (310) for filtering the list of hospital recommendations displayed on the user interface (310), in accordance with various embodiments of the present invention. In an embodiment, the user interface (310) includes a list of locations. Example of location may include, but is not limited to a state name, a country name, a city name, a metro city name, an area name, and a street name. The user (102) may choose one of the locations to filter out the list of hospital recommendations displayed on the user interface (310).

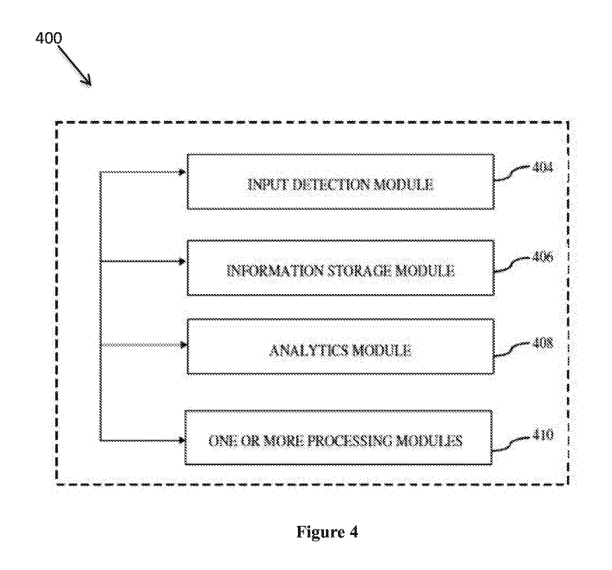

Referring to the FIG. 4 illustrates a block diagram (400) of the hospital recommendation platform (108), in accordance with various embodiments of the present invention. The block diagram (400) of the hospital recommendation platform (108) includes an information storage module (406), an input detection module (404), one or more processing modules (410) and an analytics module (408).

In accordance with one embodiment of the present invention, the input detection module (404) of the hospital recommendation platform (108) detects the input search criterion. In an embodiment, the user (102) inputs the search criterion through the communication device (104). In an embodiment, the user (102) inputs the search criterion directly on a graphical user interface of the hospital recommendation platform (108). In an embodiment, the detection module (404) may include a user interface for receiving input search criterion. In an embodiment, the user interface is a search box. Search boxes are accompanied by a search button. In another embodiment, the user interface is an input text box. In yet another embodiment, the user interface is a search field.

In accordance with one embodiment of the present invention, one or more processing modules (410) of the hospital recommendation platform (108) process the input search criterion and identify one or more hospital correspondence to the search criterion. In an embodiment, the one or more processing module (410) is associated with a memory module. The memory module accessible by the one or more processing module (410) receives and stores data. The memory module may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The one or more processing module (410) may access the memory module to retrieve data. Examples of one or more processing module includes, but are not limited to a central processing unit (CPU), a front-end processor, a microprocessor, a graphics processing unit (GPUNPU), a physics processing unit (PPU), a digital signal processor, and a network processor. Furthermore, the analytics module 408 of the hospital recommendation platform 108 identifying one or more hospitals further includes obtaining a list of doctors affiliated to a hospital based on a first scoring method, applying a second scoring method to the obtained list of doctors, and calculating a score for the hospital based on a cumulative score obtained from the second scoring method. The cumulative score is an aggregate score of the list of doctors affiliated to the hospital. The first scoring method comprising calculating a score for a doctor based on at least one of the various weights to each attributes and strengths of association of each attributes with the input search criterion. If there are multiple affiliations for a particular doctor, the hospital recommendation platform 108 gives weights to each affiliation based on, but not limited to, the size of the hospital and number of affiliated hospitals for the given doctor.

In accordance with one embodiment of the present invention, the analytics module (408) of the hospital recommendation platform (108) compares one or more hospitals based on the parameter and provides a list of hospital correspondence to the search criterion. In an embodiment, the parameter is the cumulative score obtained from the second scoring method. In an embodiment, the hospital having a higher score is displayed on the top. In an embodiment, providing a list of hospital correspondence to the search criterion is not based on a single attribute of affiliated doctors, rather, it is based on various attributes in different domains of affiliated doctors. Examples of the domains include, but are not limited to Clinical expertise for a search term, Research contributions related to search term, and Subject authority. The subject authority is based on education contributions, leadership roles held among peers and number of referrals. Examples of attributes include, but is not limited to number of publications as first or last author for each search term, number of publications not as first or last author for each search term, number of citations for publications in which the doctor is first or last author for each search term, number of citations for publications in which the doctor is not a first or last author for each search term, ratio of original article and total publications, ratio of human studies and total publication, number of patients a doctor sees with a particular disease, number of a particular medicine prescribed by a doctor, number of a particular procedure performed by a doctor, invited chapters in a book on a particular topic, leadership positions in a national organization, number of referrals from peers, and honor in local and regional chapters. In an embodiment, the scoring mechanism includes assigning various weights to each attribute of affiliated doctors. In another embodiment, the scoring mechanism includes analyzing strengths of association of each attribute with the input search criterion. Further, for a given search criterion, the score for a hospital will be calculated based on the sum of scores for affiliated doctors. The affiliated doctors' scores will be based on at least one of the various weights to each attribute and strengths of association of each attribute with the input search criterion. For a particular search criterion, the hospital associated with highest score will be displayed on the top. In an embodiment, displaying a list of hospital recommendations based on the descending order of the score. In an embodiment, the hospital recommendation is unbiased. The hospital recommendation platform (108) does not require input from either patients or hospitals and thus avoids a bias. In an embodiment, the hospital recommendation platform (108) provides personalized hospital recommendations based on the “Search Term”. Furthermore, the hospital recommendation platform (108) displays a list of hospital recommendation in various forms. Example of various forms includes, but is not limited to a graphical chart, a tabular form, voice guidance, a multimedia element, an animated report, and an interactive web element.

In accordance with one embodiment of the present invention, the information storage module (406) of the hospital recommendation platform (108) stores information related to one or more hospitals and information related to a user. In an embodiment, the information storage module (406) is a multi-tier storage system. In another embodiment, the information storage module (406) stores the information in an encrypted format. In yet another embodiment, the information storage module (406) stores the information in an indexed format. The storage module (406) facilitates storage, retrieval, modification, and deletion of data in conjunction with various data-processing operations. Storage module information may be retrieved through queries using keywords and sorting commands, in order to rapidly search, rearrange, group, and select the field.

In accordance with one embodiment of the present invention, the storage module (406) is secure web servers and Hypertext Transport Protocol Secure (HTTPS) capable of supporting Transport Layer Security (TLS. Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Users skilled in the art and technology to which this application pertains will appreciate that alterations and changes in the described structures and methods of operation can be practiced without meaningfully departing from the principle, spirit and scope.

What is claimed is:

1. A method for generating a hospital recommendation to a user (102), said method for generating said hospital recommendation to said user (102) comprising:
a. receiving an input search criterion by a hospital recommendation platform (108) using one or more communication devices (104; 114);
b. identifying one or more hospital according to said received input search criterion based on a plurality of attributes of one or more affiliated doctors classified under a plurality of domains;
c. comparing one or more identified hospitals based on a parameter; and
d. displaying a list of hospital to said user (102) corresponding to said received input search criterion.

2. The method as claimed in claim 1, wherein identifying one or more hospitals further comprising:
a. obtaining a list of doctors affiliated to a hospital based on a first scoring method;
b. applying a second scoring method to the obtained list of doctors; and
c. calculating a score for the hospital based on a cumulative score obtained from said second scoring method.

3. The method as claimed in claim 1, wherein said parameter for comparing one or more identified hospitals is said cumulative score obtained from said second scoring method.

4. The method as claimed in claim 1, wherein said plurality of attributes of affiliated doctors for identification of one or more hospitals is selected from a group comprising of clinical expertise, research contribution, education contribution, subject authority, authorship, number of academic publications as first, subsequent or last author, number of citations for said publications, invited chapters in a book on a particular topic, ratio of original article and total publications, ratio of human studies and total publication, number of patients said one or more doctor with a particular disease, number of a particular medicine prescribed by said one or more doctor, number of a particular procedure performed by said one or more doctor, and leadership role in a national organization, number of referrals from peers, and honor in local and regional chapters of said one or more doctor pertaining to said input search criterion.

5. The method as claimed in claim 1, wherein said input search criterion is based on at least one disease, procedure and medicine.

6. The method as claimed in claim 1, further comprise of enabling auto completion of said input search criterion.

7. The method as claimed in claim 1, wherein said list of hospitals is displayed in a descending or an ascending order of based on said scoring mechanism.

8. The method as claimed in claim 1, wherein said list of hospital is displayed to said user (102) corresponding to said received input search criterion in form of a graphical chart, a tabular form, voice guidance, a multimedia element, an animated report, or an interactive web element.

9. The method as claimed in claim 2, wherein said first scoring method comprising calculating a score for a doctor based on at least one of various weights to said plurality of each attributes and strengths of association of said plurality of attributes with said input search criterion.

10. The method as claimed in claim 2, wherein said cumulative score is an aggregate score of said list of doctors affiliated to said hospital.

11. A system (100) for generating a hospital recommendation to a user (102) using a hospital recommendation platform (108) communicatively coupled with one or more communication devices (104; 114) through a communication network (110), said system (100) for generating said hospital recommendation to said user (102) comprising:
a. an input detection module (404), configured to receive, detect and interpret an input search criterion by said hospital recommendation platform (108) using one or more communication devices (104; 114);
b. an information storage module (406), configured to store information related to one or more hospital and information related to said user (102);
c. an analytics module (408), configured to compare one or more identified hospital based on a scoring mechanism and provide a list of hospital correspondence to said input search criterion; and
d. one or more processing modules (410), configured to process said input search criterion and identify one or more hospital corresponding to said input search criterion based on a plurality of attributes.
